(19) United States
(12) Patent Application Publication
(10) Pub. No.: US 2010/0031829 A1
(43) Pub. Date: Feb. 11, 2010

(54) Food container liquid isolation

(76) Inventor: Terry Vovan, Upland, CA (US)

Correspondence Address: LEON D. ROSEN;FREILICH, HORNBAKER & ROSEN, Suite 1220, 10960 Wilshire Boulevard, Los Angeles, CA, 90024, US

(21) Appl. No.: 12/228,168

(22) Filed: Aug. 8, 2008

(51) Int. Cl. A47J 43/00; B65D 6/00; B65D 51/16

(52) U.S. Cl. 99/495; 220/608; 220/361

(57) ABSTRACT

Apparatus (10) for holding food includes a food container (12) with a bottom wall and a plurality of support ribs (20) that extend up from much of the bottom wall and form recess regions (22) between ribs for holding liquids that drip off the food. A sealing film (24) lies on the support ribs and extends over the recess regions. The sealing film has pores that allow liquid on the food to migrate downward into the recesses, while preventing the splashing of liquid up through the film onto the food.

### BACKGROUND OF THE INVENTION

Food for sale is often packaged in transparent plastic containers that are preferably constructed from deformed plastic sheets for low cost. Many foods have liquids that drip off the foods, such as cooked and uncooked red meat, chicken, fish and other seafoods and cut fruits including watermelon, tomatoes and pineapple. When the food is held in a container, it is desirable that the liquid (e.g. blood from meat) be stowed away from the food to make the food more appetizing and avoid dripping on the clothes of the eater and to prolong the food shelf life. One approach has been to place absorbent material on the bottom of the food container to absorb the liquids. The absorbent material adds to the cost of the container and may absorb liquid that would not drip from the food so the absorbent material may “dry-out” the food. A container that collected only liquid that drips off food, and that collected it in a region that is away from the food while preventing the liquid from splashing back onto or above the food, would be of value.

### SUMMARY OF THE INVENTION

In accordance with one embodiment of the invention, a low cost container is provided for holding food from which liquids drip, which collects dripped liquids in a region that is isolated from the food and that resists splashing of the liquid back onto the food. The container has a bottom wall and has a plurality of support ribs that support food above the bottom wall. The ribs form recess regions between them, for receiving the liquids. A sealing film extends over a shelf that extends around the container cavity, and over the ribs and the recess regions between them. The film has pores that allow liquid that drips onto the film to migrate through the film into the recesses but prevents splashing of the liquid above the film. The recess regions can be separated regions, or merging regions, with the separated regions having the advantage of better preventing liquid sloshing.

In one apparatus, the film is initially impenetrable to liquid, but a center region of the film is formed with pin holes to allow liquid to flow down into the recesses. The opposite sides or ends of the film do not have pin holes, so the container can be tilted to better display the food, without the liquid flowing above the film. In one apparatus, the container has a small height and is dropped into a much taller receptacle. This avoids the need to heat-bond the film to the ribs while the ribs lie at the bottom of a tall container.

The novel features of the invention are set forth with particularity in the appended claims. The invention will be best understood from the following description when read in conjunction with the accompanying drawings.

### DESCRIPTION OF THE DRAWINGS

FIG. 1 is a top isometric view of apparatus of the present invention which includes a container and a sealing film.

FIG. 2 is a partial sectional view of the apparatus of FIG. 2.

FIG. 3 is an enlarged view of a portion of FIG. 1.

FIG. 4 is a top isometric view of apparatus of another embodiment of the invention wherein the container is of small height and lies at the bottom of a receptacle.

FIG. 5 is a sectional view of a portion of the apparatus of FIG. 4.

FIG. 6 is a top view of apparatus of another embodiment of the invention, wherein the container forms channels for quickly draining fluid.

FIG. 7 is an isometric view of a portion of the apparatus of FIG. 6.

FIG. 8 is a top isometric view of apparatus of another embodiment of the invention, wherein the sealing film is joined to an inclined deck that extends around the inside of the container bottom portion.

FIG. 9 is a partial isometric view of the container and sealing film of FIG. 8.

FIG. 10 is a top isometric view of apparatus of another embodiment of the invention wherein the film-supporting surface of the deck and ribs is inclined from the horizontal.

FIG. 11 is an exploded top isometric view of apparatus of another embodiment of the invention, wherein the container is of small height and receives a tall dome for displaying the food.

FIG. 12 is a top isometric view of the apparatus of FIG. 11 with the dome assembled on the container.

FIG. 13 is a top isometric view of apparatus of another embodiment of the invention wherein the container is constructed to support itself in a display mode as well as a storage mode.

FIG. 14 is an isometric view of the container of FIG. 13 in a display mode.

### DESCRIPTION OF THE PREFERRED EMBODIMENTS

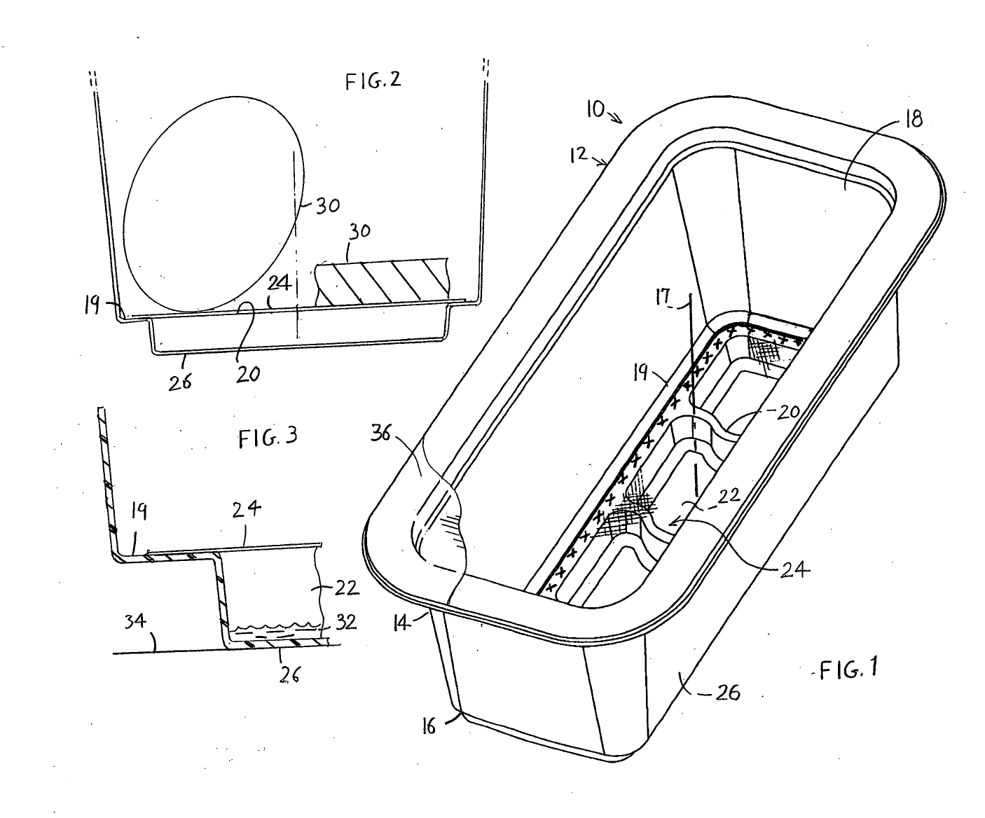

FIG. 1 illustrates apparatus 10 of generally rectangular shape for holding food, which includes a container 12 that has top and bottom portions 14, 16 and a vertical axis 17. The container has a cavity 18, an internal deck 19 in the lower portion of the cavity, and a plurality of support ribs 20. The support ribs leave recess regions 22 between them, that can hold fluid. A sealing film 24 lies on the deck and on the ribs and is bonded to them, as by heat bonding. The sealing film is usually transparent, although it can be opaque and white. The container is preferably constructed by vacuum forming a plastic sheeting such as a sheet of transparent plastic (of various colors), and the ribs are created by upward projections in the lower surface of a bottom wall 26 of the container. FIG. 2 shows food 30 lying on the sealing film 24, which in turn, is supported by the deck 19 and ribs 20. FIG. 3 shows a small amount of fluid 32 lying in a recess region 22 that has dripped off solid parts of the food, and with the container lying on a horizontal surface 34. A lidding, or beathable film 36 can lie over fresh food.

The sealing film 24 can be formed from a sheet of film that has pores that allow fluid to migrate through the film and drop vertically into a recess region. The pores slow the fall of liquid to less than one-tenth the volume per unit time at which it would flow down in the absence of the film or any other barrier to the liquid falling. A common sealing film allows fluid to flow in opposite directions through the film, and a film is available that allows fluid flow in only one direction (down) through the film. Either type of film is acceptable in the present application, provided that it can support the weight of a piece of food (e.g. one-half kilogram, or one pound) when extending between ribs that are spaced (e.g. by up to 7 cm). With the film in place, food 30 in FIG. 2 can rest on a film portion that lies on a rib 20 or a film portion that extends between ribs without harm to the film. The film can be fixed to the top surfaces of the ribs 20 and to the shelf 19 that lies within the perimeter of the container bottom portion by heat welding or other means, or may be fixed only to the shelf. The pores in the film preferably each has a cross-section of no more than five thousandths square inch and preferably no more than one thousandth square inch.

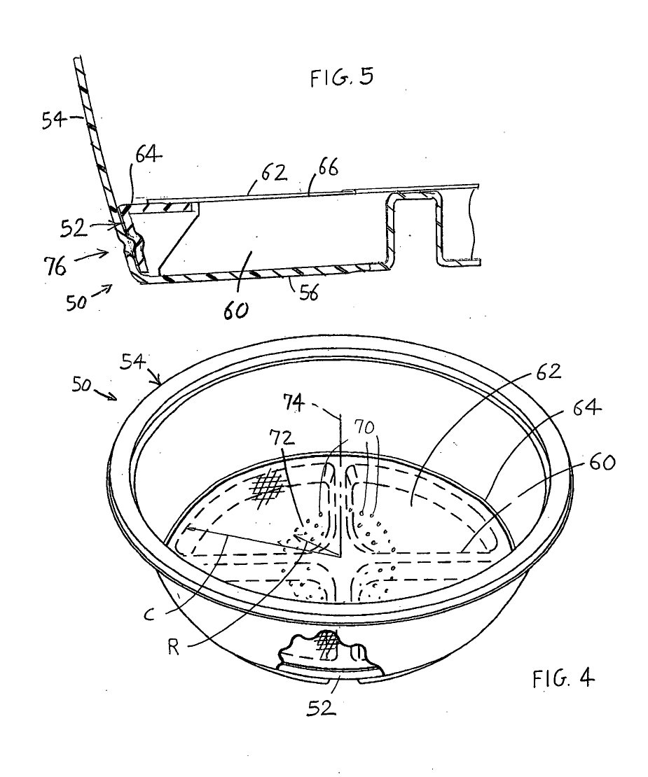

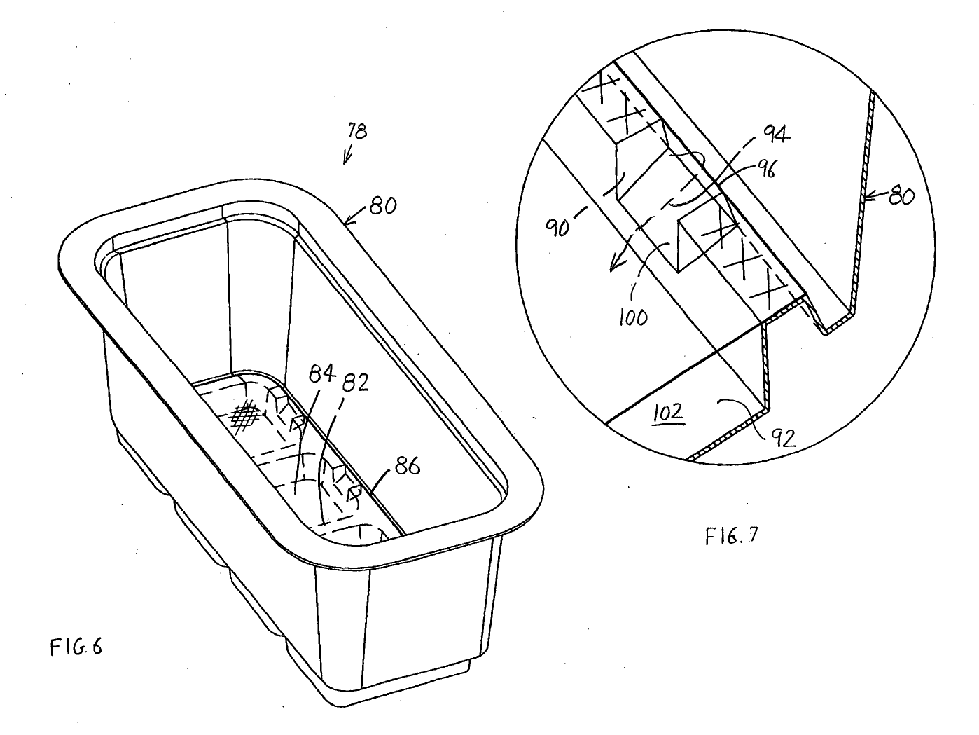

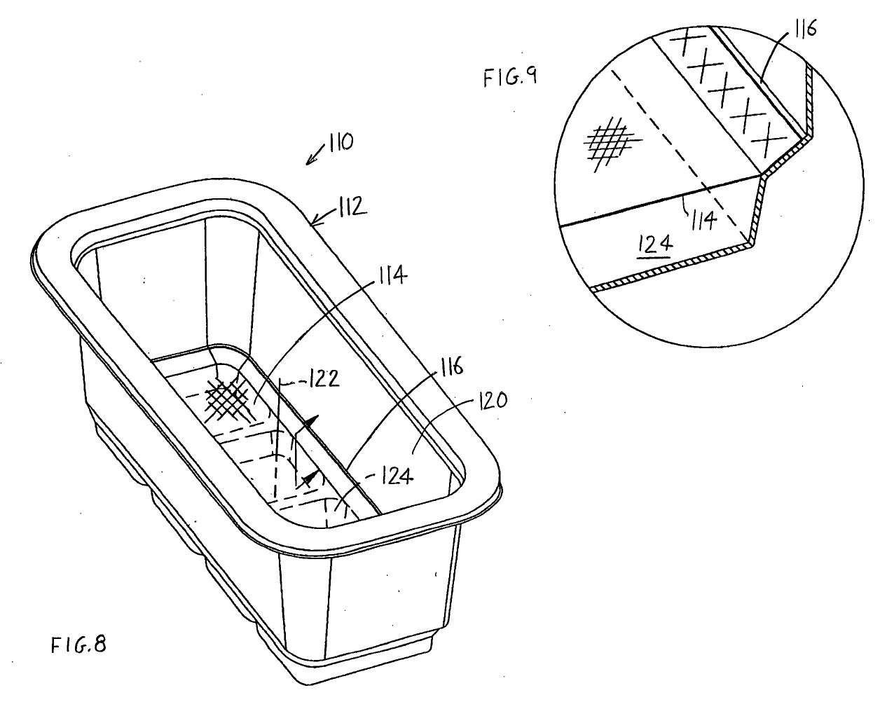

FIGS. 4 and 5 show a food holding apparatus 50 of circular shape as seen from above, which includes a container 52 of small height, lying within a receptacle 54 of much greater height. In this case, the bottom wall 56 of the receptacle has upstanding projections that form the ribs 60, although it is possible to construct the container so the receptacle forms the ribs. The advantage of this arrangement which uses a container 52 of small height is that the sealing film 62 can be heat bonded, or otherwise bonded to a shelf 64 at the perimeter of the container, before the container is dropped into the receptacle. In this case, the sealing film 62 is not bonded to the top 66 of the ribs, but the film will support the weight of food because of its bonding to the shelf 64 and support by the ribs.

In FIG. 4, the film 62 does not allow migration of fluid through it until altered by punching pin holes 70 in a middle portion 72 of the film. This allows the receptacle to be displayed in a tilted position, at a tilt angle such as up to 30° from the position of FIG. 4 where the receptacle bottom is horizontal, to better display the food. The film area with pin holes has a radius R in any horizontal direction as measured from the axis 74, that is less than 75% of the recess area radius C in that direction. The receptacle and container are each formed of a deformed plastic sheet, and are formed with projections that form a latch 76. The latch resists pullup of the container after it has been pressed down into the lower portion of the receptacle.

FIGS. 6 and 7 illustrate an apparatus 78 that includes a container 80 with upstanding support ribs 82 and with a sealing film 84 lying on the ribs and on a shelf 86 at the periphery of the container lower portion. The shelf 86 forms a plurality of drain channels 90 for the rapid draining of fluids into the recess regions 92 between ribs (and within the shelf). If there is fluid to be drained that might clog the pores of the sealing film, such fluid can pass along the path of arrow 94 around the edge 96 of the sealing film, through the channel 90 with a downward-inward inclined channel bottom 100 that lies a distance above the bottom 102 of the recess region and into the recess region. Each channel has a width of a plurality of millimeters.

FIGS. 8 and 9 show another apparatus 110 that includes a container 112 and a sealing film 114. The container is formed with a shelf 116 extending around the periphery of the container cavity 120, and the sealing film is bonded to the shelf. FIG. 9 shows that the shelf 116 is tilted at a downward-inward tilt toward the axis 122 of the container. Any liquid that rests on the film portion that lies on the shelf, tends to flow down the incline to a film portion that lies over a recess region 124 and migrate downward into the recess region.

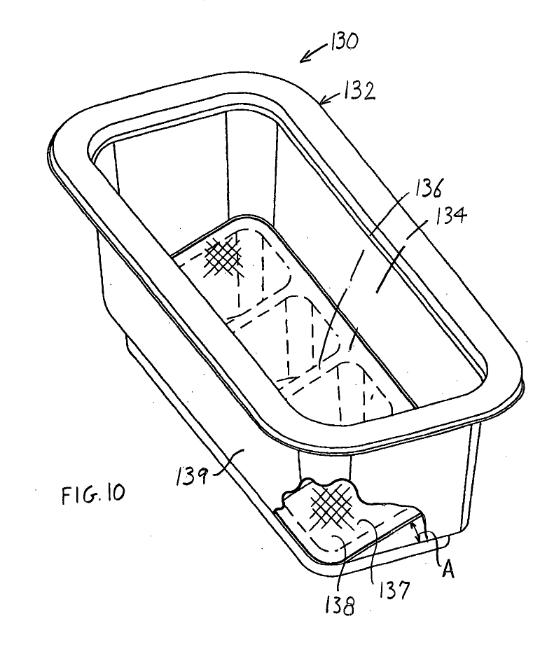

FIG. 10 illustrates apparatus 130 wherein the container 132 has a shelf 134 and support ribs 136 with upper ends, that are all tilted from the horizontal. The tilt angle A is at least 5° and preferably at least 10° from the horizontal, but no more than 60° from the horizontal. The tilt angle is preferably about 30° from the horizontal. This results in a tilted food support surface 137 on a sealing film 138 that better displays food in the container when the container lies on a high horizontal shelf. At least the receptacle side wall 139 that extends furthest above the end of the support surface 137 that it contacts, is transparent.

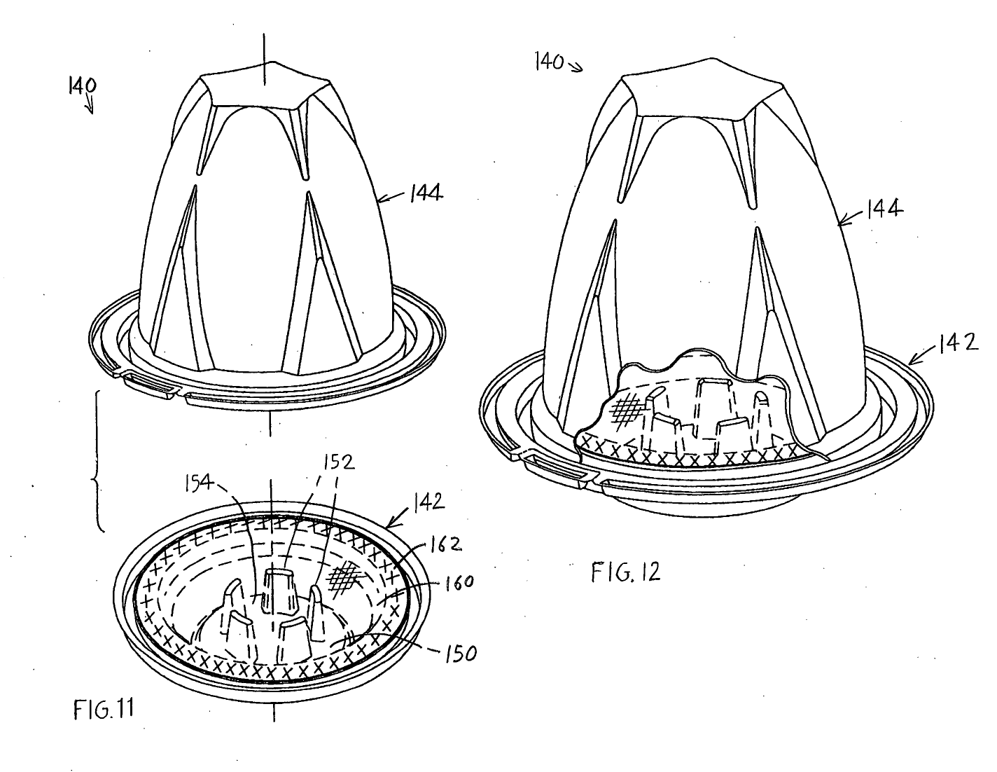

FIGS. 11 and 12 illustrate an apparatus 140 for displaying food, which includes a container 142 of short height, and a display dome 144 that covers the top of the container while displaying the food. The container has a bottom wall 150 and has upward projections that forms ribs 152. The ribs are not connected to each other, so the recess regions 154 include regions that lie within and outside the circle of ribs 152 and regions that lie between adjacent sides of adjacent ribs. A sealing film 160 covers the top 162 of the container.

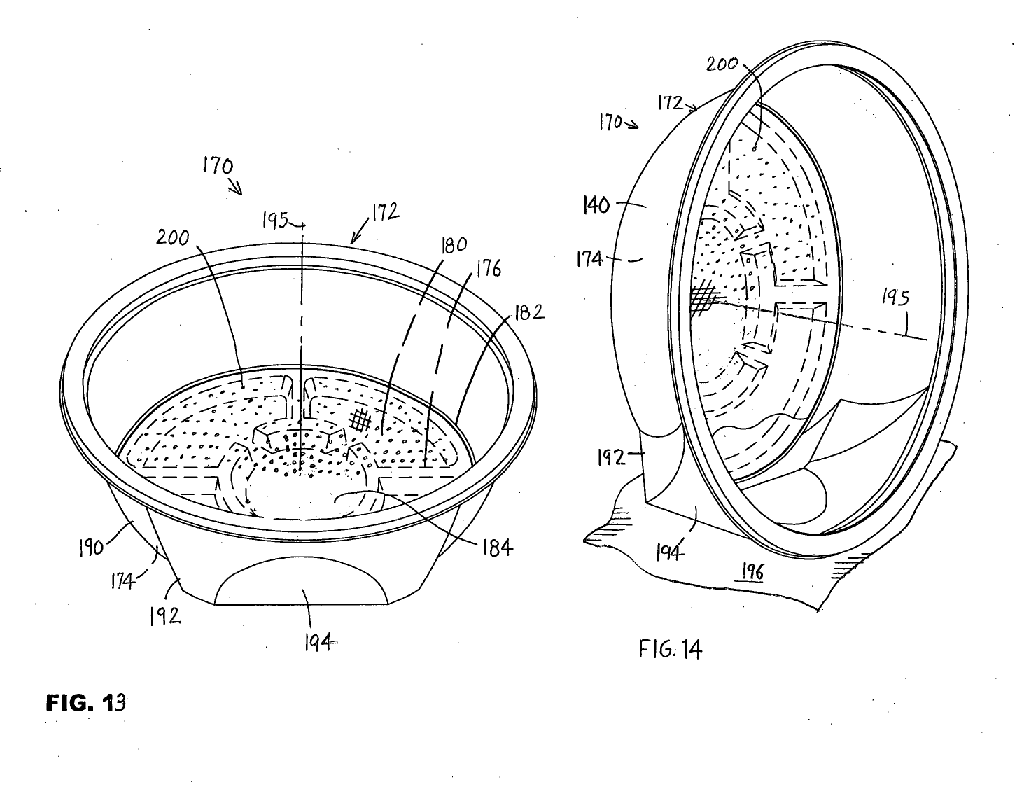

FIGS. 13 and 14 illustrate an apparatus 170 which includes a plastic sheet formed into a container 172. The container has a bottom wall 174 with upward projections forming ribs 176 and has recess regions 180 between adjacent ribs. The container also forms an internal deck 182. A film 184 is bonded to the ribs and deck. The container has side walls 190 that are round, except for a projection 192 with a flat side support surface first location 194 that extends to the bottom wall 174. FIG. 13 shows the bottom wall resting on a flat horizontal surface with the film 184 facing primarily vertically along axis 195. FIG. 14 shows the container resting stably in a display position wherein the support surface 194 lies on a horizontal surface 196 such as a table top with the sealing film facing primarily horizontally. The film 184 has multiple holes 200 (each preferably less than 1 mm diameter) lying in an upper portion of the film in the container position of FIG. 14. A one-way film which has pores in its entire surface can be used instead.

Thus, the invention provides apparatus for holding food that may include liquids, which drains away the liquids into recess regions that lie in a container under a sealing film that has pores that allow the downward migration of fluid into the recess regions. The apparatus prevents the drained fluids from rapidly moving up out of the recesses, even if the container is suddenly moved to one side or is tilted and such movement causes splashing of the liquid. The apparatus can include a short container that lies in a taller receptacle, with the sealing film bonded to the container before the container is dropped into the receptacle. A short container can be covered by a display dome that extends high over the container. The container can have a side that rests stably on a horizontal support surface. The container can have a round, rectangular, or any other shape, and can be made of a polymer or various pulp materials or both.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. Apparatus for holding food that includes liquids, which includes a container (12) that has a bottom wall (26) and a plurality of support ribs (20) that support the food and that form a plurality of downward recess regions (22) between said ribs for receiving liquids that drip off solid parts of the food, including:
a sealing film (24) that extends over a plurality of said recess regions and that is supported by a plurality of said ribs, said film constructed to allow the passage of liquid through it.

2. The apparatus described in claim 1 wherein:
said film allows liquid to migrate through it more readily in a first direction than a second direction, and said film is oriented so said first direction is primarily downward.

3. The apparatus described in claim 1 wherein:
said support ribs form said recess regions as a plurality of recesses that are isolated from each other, to resist sloshing of liquid.

4. The apparatus described in claim 1 wherein:
said container has a bottom that rests in an initial position on a flat horizontal surface (34);
said recess regions occupy a total recess area that is a majority of the area of said container as seen in a top view, and said sealing film has pores only at a center region that has a radius (R) no more than 75% of the radius (C) of said recess area, to avoid liquid movement up out of said recess area if the container is tilted from an original position.

5. The apparatus described in claim 1 wherein:
said container has side walls that form at least one channel (90) through which fluid flows rapidly and that extends from above said sealing film (96) to below it, to enable the rapid flow of a large amount of liquid into at least one of said recess regions.

6. The apparatus described in claim 1 including:
a receptacle (54) having a lower portion of larger width and length than said container, said container (52) lying in a lower portion of said receptacle.

7. The apparatus described in claim 6 wherein:
said receptacle and container are each formed of a sheet of plastic with projections that form a latch that resists pullup of the container out of the lower portion of the receptacle.

8. The apparatus described in claim 1 wherein:
said container has a top (162) and said sealing film (160) lies at said container top; and including
a quantity of food lying on said sealing film;
a display dome (144) that fits around and over said food.

9. The apparatus described in claim 1, wherein:
said container has side walls and said apparatus forms a deck (116) that extends inward from said container side walls, with said film (114) bonded to said deck.

10. The apparatus described in claim 1 wherein:
said bottom wall is constructed to lie stably on a flat horizontal surface and said sealing film faces primarily upward when said bottom wall lies on the flat horizontal surface;
said container has side walls with a first location along said side walls constructed to lie stably on said flat horizontal surface with said sealing film facing primarily horizontal.

11. The apparatus described in claim 10 wherein:
said sealing film has multiple holes at an upper portion of said film when said side walls first location lies on a flat horizontal surface.

12. The apparatus described in claim 1 wherein:
said bottom wall is constructed to lie on a horizontal surface;
said container has a transparent side wall (139), and said container has a support wall (137) that is tilted from said bottom wall to display food through said transparent side wall.

13. Apparatus for holding food that includes liquid and for separating out some of said liquid, which includes a container (12) with side walls and a bottom (26), said bottom forming a plurality of upstanding ribs (20) with top surfaces and a plurality of recess regions (22) between said ribs, comprising:
a sealing film (24) that extends over said ribs and said recess regions and that is attached to said rib top surfaces, said sealing film having a plurality of pores that allow liquid on top of said film to migrate through the film to the recesses, each pore having a cross-sectional area large enough to allow said liquid but not said food to pass through.

14. The apparatus described in claim 13 wherein:
each of said pores has a cross-sectional area of no more than one thousandth square inch.

15. The apparatus described in claim 13 wherein:
said support ribs form said plurality of recess regions into regions separated by said ribs.

16. The apparatus described in claim 13 including:
a receptacle (54) having side walls and a bottom portion;
said container lying at said bottom portion of said receptacle, with said container having a height less than half the height of said receptacle.

17. The apparatus described in claim 13 wherein:
said container has a shelf (19) extending inward from said container side walls, with said film attached to said deck.

18. The apparatus describe in claim 13 wherein:
said bottom rests stably on a flat horizontal surface with said film facing primarily vertically, and said side walls include a side wall first location that rests stably on the flat horizontal surface with said sealing film facing primarily vertically.

19. Apparatus for holding food that includes liquids, comprising:
a container constructed of formed plastic sheeting and having a top and a bottom;
means forming a plurality of ribs within the container at its bottom and forming a plurality of recess regions between the ribs;
a sealing film lying on said ribs and fixed in place, said film constructed to allow liquid to flow downward through the film to flow into said recesses.
